(19) United States
(12) Patent Application Publication
(10) Pub. No.: US 2008/0225877 A1
(43) Pub. Date: Sep. 18, 2008

(54) SWITCHING APPARATUS AND FRAME EXCHANGING METHOD

(75) Inventor: KATSUJI YOSHIDA, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC CORPORATION, Tokyo (JP)

(21) Appl. No.: 12/048,693

(22) Filed: Mar. 14, 2008

(30) Foreign Application Priority Data
Mar. 15, 2007 (JP) JP2007-066415

(51) Int. Cl. H04L 12/56

(52) U.S. Cl. 370/419

(57) ABSTRACT

A switching apparatus is provided which performs switching of a frame sent from a node, in a system of the switching apparatus and the node having redundant ports. The switching apparatus generates a virtual port based on an external setting signal, relates the redundant ports to the virtual port, and sends the frame to one of the ports of the node related to the virtual port when the frame is destined to the virtual port.

### TECHNICAL FIELD

The present invention relates to a technique for reducing a process when a trouble is generated, with regard to a switching apparatus for establishing a network. This patent application is based on Japanese Patent Application No. 2007-066415. The disclosure of the Japanese Patent Application is incorporated herein by reference.

### BACKGROUND ART

In a storage area network (SAN) environment in which a switching apparatus is used, typically, there are a plurality of routes from a server to a data storage position in a disc apparatus. This is because a switching apparatus connects routes in a net. Thus, even if any one route cannot be used because of a fault, a different route can be used, and since loads are distributed, traffics are prevented from being concentrated to a particular route. Thus, a response time can be prevented from being long.

Japanese Patent Application Publication (JP-P2005-210166A) describes a technique that a data is sent between the port control sections, and a continuous operation of a network is attained in order to automatically avoid a fault of a fiber channel switch, when the fault is generated in a port control section and a switch circuit in the fiber channel switch.

In a switching apparatus in related arts, from the viewpoint of the preparation for the increase in a transfer performance, the attainment of a load distribution, and reservation of a spare path in the generation of a fault, the server and the disc apparatus are connected by a plurality of paths. Specifically, a server contains a plurality of HBAs (Host Bus Adapters), which are connected to a switching apparatus in a redundant configuration. Also, a disc apparatus has a plurality of redundant ports, which are also connected to the switching apparatus. In such a configuration, even if one of the HBA or the ports of disc apparatus is failed, communication can be continued by using the remaining HBAs and ports of the disc apparatus. Thus, it is possible to attain the operation having a high reliability.

However, in this case, the number of routes (paths) from the server to any recording disc in the disc apparatus is equal to a product of the number of paths between the server and the switching apparatus and the number of paths between the disc apparatus and the switching apparatus. For this reason, when the paths between the server and the disc apparatus should be increased, the number of paths increases in proportional to the product. As a result, the number of paths to be managed by the server increases dramatically, and also the resource for managing the paths greatly increases in the server. For example, when a fault is generated in one port in the disc apparatus, the server needs to carry out an error process to inhibit all the paths from being used, since errors are generated in all the paths connected to this port. Therefore, the resource of the server is wastefully spent.

### SUMMARY

An object of the present invention is to provide a switching apparatus in which a plurality of ports having one or more routes from the switching apparatus to a particular node are virtually integrated into a single section.

In an exemplary embodiment of the present invention, a switching apparatus is provided which performs switching of a frame sent from a node, in a system of the switching apparatus and the node having redundant ports. The switching apparatus generates a virtual port based on an external setting signal, relates the redundant ports to the virtual port, and sends the frame to one of the ports of the node related to the virtual port when the frame is destined to the virtual port.

In another exemplary embodiment of the present invention, a frame exchanging method is provided in a system of a switching apparatus and a node having redundant ports. The frame exchanging method includes generating a virtual port based on an external setting signal; relating one or more of the redundant ports of the node to a virtual port; and sending the frame to one of the ports related to the virtual port when a destination of the frame is the virtual port.

In another exemplary embodiment of the present invention, a computer-readable software product is provided in which a program of codes is written to execute a frame exchanging process. The frame exchanging process is in a system of a switching apparatus and a node having redundant ports. The frame exchanging process includes generating a virtual port based on an external setting signal; relating one or more of the redundant ports of the node to a virtual port; and sending the frame to one of the ports related to the virtual port when a destination of the frame is the virtual port.

### BRIEF DESCRIPTION OF THE DRAWINGS

The above and other objects, advantages and features of the present invention will be more apparent from the following description of certain exemplary embodiments taken in conjunction with the accompanying drawings, in which:

FIG. 1 is a block diagram showing a configuration of the switching apparatus in the first exemplary embodiment;

FIG. 2 is a diagram showing a configuration of a frame transferred from a switch section in the first exemplary embodiment;

FIG. 3 is a block diagram showing a physical connection relation in the system according to the first exemplary embodiment of the present invention;

FIG. 4 is a block diagram showing a logical connection relation of the system in which a virtual port is not used in the first exemplary embodiment of the present invention;

FIG. 5 is a block diagram showing the logical connection relation of the system in which the virtual port is used in the first exemplary embodiment of the present invention;

FIG. 6 is a diagram showing a configuration data of the virtual port stored in a virtual port storage section in the first exemplary embodiment of the present invention;

FIG. 7 is a flowchart showing an operation of the switching apparatus in the first exemplary embodiment of the present invention;

FIG. 8 is a diagram showing the configuration data of the virtual port stored in the virtual port storage section in a second exemplary embodiment of the present invention; and

FIG. 9 is a flowchart showing an operation of the switching apparatus in the second exemplary embodiment of the present invention.

### EXEMPLARY EMBODIMENTS

Hereinafter, a switching apparatus according to exemplary embodiments of the present invention will be described in detail with reference to the attached drawings. FIG. 1 is a block diagram showing a configuration of the switching apparatus in the first exemplary embodiment.

### First Exemplary Embodiment

With reference to FIG. 1, the switching apparatus in the first exemplary embodiment includes ports 20, a switch section 21, a control section 22, a route data storage section 23, a virtual port managing section 24, a virtual port storage section 25, a virtual port searching section 26 and a frame rewriting section 27.

The ports 20 are connected to HBAs (Host Bus Adapter) of a server and a plurality of ports of a disc apparatus, although they are not shown. In addition to the above configuration in which the server and the disc apparatus are directly connected to the switching apparatus 2, a configuration may be employed in which the server and the disc apparatus are connected through one or more switching apparatuses. In this case, a different switching apparatus is connected to the ports 20 of the switching apparatus 2, and a frame is sent from the server to the disc apparatus through the plurality of switching apparatuses.

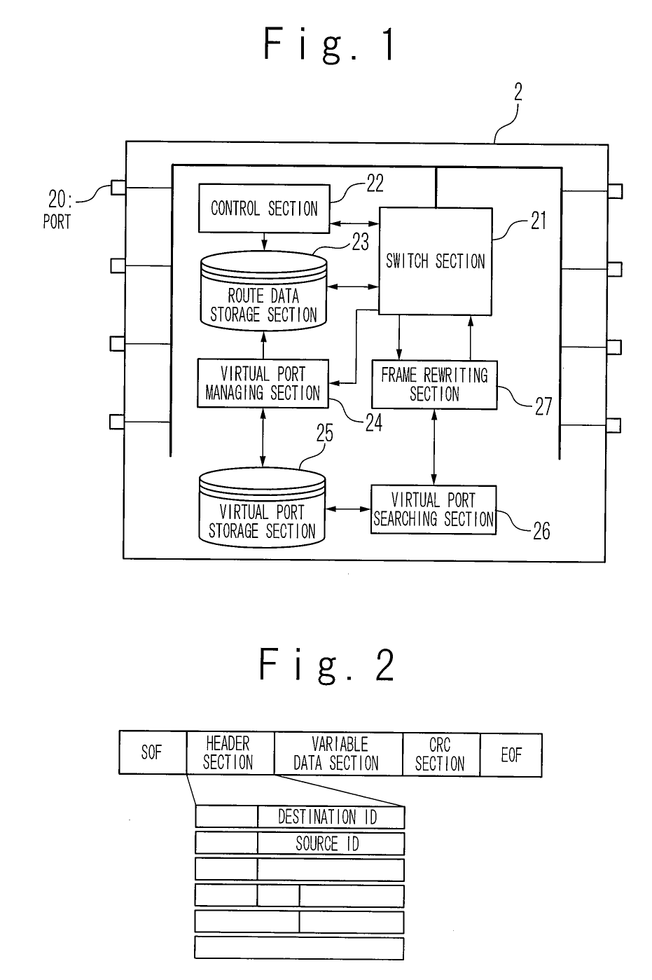

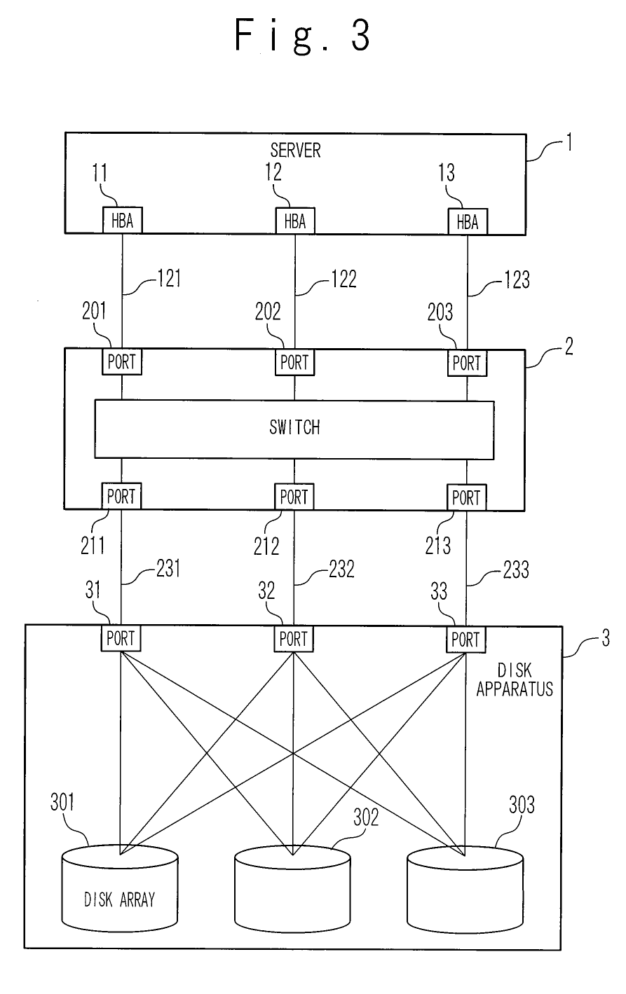

FIG. 2 is a diagram showing a configuration of the frame transferred from the switch section 21 in the first exemplary embodiment. The frame starts with SOF (Start Of Frame) and ends with EOF (End Of Frame). A header section, a variable length data section and a CRC (Cyclic Redundancy Check) section are inserted between those two. A destination ID as an apparatus ID of a transmission destination of the frame and a source ID as an apparatus ID of a transmission source of the frame are set in the header section. Also, a data transferred by using the frame is placed in the variable length data section, and a value obtained when CRC of the frame is calculated is set in the CRC section to check validity of the data of the frame.

It should be noted that in the first exemplary embodiment, a fiber channel frame is assumed as a frame to be transferred. However, the configuration of the frame is not limited to the foregoing structure, and it is sufficient that the source and destination of the frame are determined from the destination ID and the source ID at least.

Next, each of the components shown in FIG. 1 will be described below in detail. The input and output of the data to and from the switching apparatus 2 are carried out through the ports 20. As mentioned above, in addition to the server and the disc apparatus, a different switching apparatus may be connected to the port 20.

When the server sends a frame, the destination ID and the source ID are set in the frame. The ID of a port of the disc apparatus as a target accessed by the server is set as the destination ID, and the ID of a port of the HBA of the server sending the frame is set as the source ID. The frame is received from the port 20 and is transferred to the switch section 21. When the frame is received from the port, the switch section 21 uses the destination ID set in the frame and searches the route data storage section 23. When a port to which the frame should be sent is determined in accordance with a route data stored in the route data storage section 23, the switch section 21 outputs the frame from the port to which the frame should be sent.

The route data storage section 23 stores the route data in relation to the port. The route data indicates that the frame can be sent to a node with a destination ID of the frame if the switch section 21 sends the frame to which of ports. When a HBA of the server and a port of the disc apparatus are directly connected to the ports 20 of the switching apparatus 2, the control section 22 sets the route data on the basis of the ID of the node connected to the port. In this case, the route data is set such that the frame having the node ID as the destination ID is sent to the above port.

Also, when another switching apparatus is connected to the ports 20, the route data possessed by each of the switching apparatuses is exchanged between the switching apparatuses. Thus, in the network constituted by the plurality of switching apparatuses, the route data stored in the route data storage section 23 is set such that a frame sent from a port of a node in the network can arrive at a port of a particular node indicated by the destination ID of the frame.

A port 20 to which the frame is to be transferred is set in the route data in relation to the destination ID of the frame. The control section 22 can always update the route data stored in the route data storage section 23 by exchanging a special frame representing the route data between the switching apparatuses. As a routing protocol to exchange the route data between the switching apparatuses, an FSPF (Fibrechannel Shortest Path First) protocol is known in a fiber channel. Also, in the first exemplary embodiment, when the switching apparatus 2 transfers the fiber channel frame, the FSPF protocol may be used. It should be noted that the routing protocol is not limited to the FSPF protocol. Any protocol may be used if the route data can be exchanged between the switching apparatuses by using the protocol to determine the route data.

The virtual port managing section 24 generates a virtual port, registers the virtual port in the route data storage section 23 and sets the virtual port. The virtual port managing section 24 generates the virtual port in response to a setting signal from the server or a managing section of the switching apparatus (not shown). The setting signal from the server or the managing section can be attained such that a destination of the frame supplied from the port 20 is defined as the virtual port and further a data indicating configuration of the virtual port is set in the data of the frame. Also, an input for the setting signal may be provided in the switching apparatus, separated from the ports 20. Moreover, the virtual port managing section 24 registers the generated virtual port in the route data storage section 23, too. Also, the virtual port managing section 24 manages ports related to the virtual ports and attribute data related to those ports as the configuration data of the virtual port, and this data is stored in the virtual port storage section 25.

The virtual port storage section 25 stores the configuration data of the virtual port set by the virtual port managing section 24. The configuration data is stored in such a manner that it is possible to search both of the ID of the port related to the virtual port from the ID of the virtual port and the ID of the virtual port from the ID of the port related to the virtual port. The virtual port searching section 26 searches the virtual port storage section in accordance with the ID of the virtual port transferred from the frame rewriting section 27 and selects one of the port IDs related to the virtual ports based on the virtual port ID and then returns the selected port ID to the frame rewriting section.

The destination ID of the frame destined to the virtual port is sent from the switch section 21 to the virtual port searching section 26 through the frame rewriting section 27, and one of the IDs of the ports related to the virtual port is acquired. Next, this ID is set in the destination ID of the frame and sent to the switch section 21.

Next, the outline of the configuration and operation of the network using the switching apparatus in accordance with the first exemplary embodiment of the present invention will be described below. FIG. 3 is a block diagram showing a physical connection relation between the server 1 containing a plurality of host bus adapters, the switching apparatus 2 connected to the server, and the disc apparatus 3 having the plurality of ports.

The server 1 contains three host bus adapters HBA 11, HBA 12 and HBA 13. The respective host bus adapters are connected to a port 201, a port 202 and a port 203 of the switching apparatus 2, respectively. Also, the disc apparatus 3 has three ports 31, 32 and 33. The respective ports are connected to respective disc arrays (a disc array 1, a disc array 2 and a disc array 3) built in the disc apparatus 3. It is possible to access all of the built-in disc arrays from each port. The respective ports of the disc apparatus 3 are connected to a port 211, a port 212 and a port 213 of the switching apparatus 2, respectively.

It should be noted that FIG. 3 shows one disc apparatus 3, one switching apparatus 2 and one disc apparatus 3. However, the present invention is not limited to such a system configuration. That is, in the present invention, a configuration can be employed in which a plurality of servers having an optional number of host adapters are connected through a plurality of switching apparatuses to a plurality of disc apparatuses having an optional number of ports. Also, the number of ports of each of the switching apparatuses is not limited to a number in this exemplary embodiment. It is sufficient that a connection relation for a redundant configuration can be attained in which there are a plurality of routes for the connection between the switching apparatus and the disc apparatus.

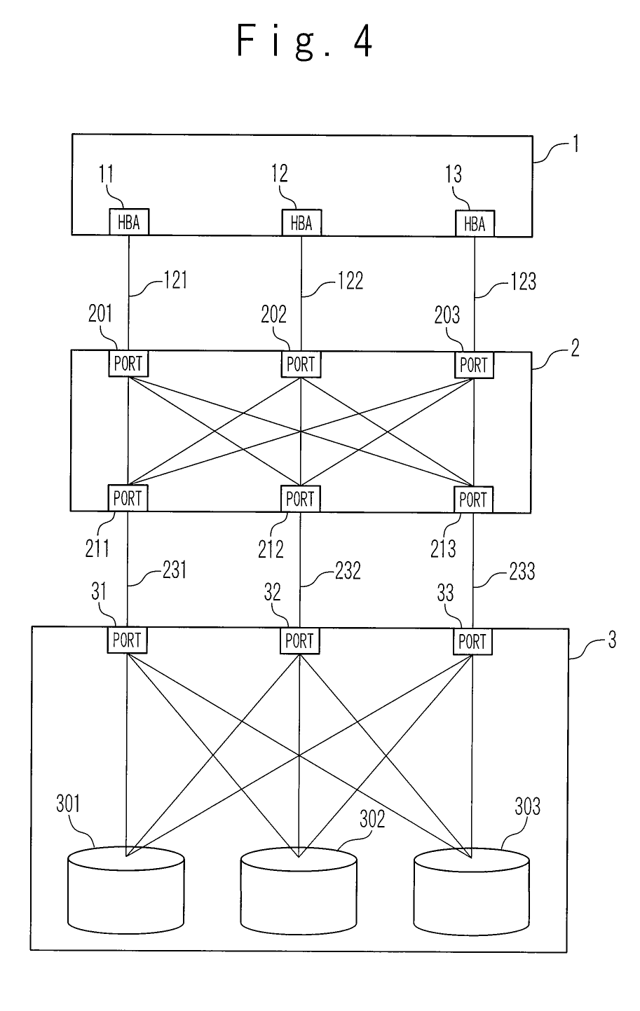

FIG. 4 is a block diagram showing a logical connection relation between the server 1 and the disc apparatus 3 when the switching apparatus 2 is operated as a usual switch, without a virtual port to be generated, in the system shown in FIG. 3. In FIG. 4, the communication between the server 1 and the disc apparatus 3 is carried out as follows. At first, a frame is sent from the server 1 to the switching apparatus 2 through any one of the host bus adapters HBA 1n (n=between 1 and 3) of the server 1. Since the server 1 contains the plurality of host bus adapters connected to the same switching apparatus 2, the connection route between the server 1 and the switching apparatus 2 can be made redundant.

The frame sent from the server 1 is supplied to the switching apparatus 2 through one of the ports, and is sent out to one of the ports connected to the disc apparatus 3. The port connected to the disc apparatus 3 is selected based on the route data of the switching apparatus 2. The disc apparatus 3 also contains the plurality of ports which allow access to the inner disc arrays, like the server 1. Thus, the connection route between the switching apparatus 2 and the disc apparatus 3 can be made redundant.

In such a configuration, the server 1 and the disc apparatus 3 are connected through the plurality of redundant connection routes. Thus, even if a part of the routes cannot be used due to a fault of the host bus adapters of the server and the ports or cables of each equipment, the access through any of the remaining routes can be carried out. Thus, an effect can be attained that the availability of the system can be made high. On the other hand, since the routes to be monitored by the server increase in proportion to the number of combinations, the monitor cost of the server is high.

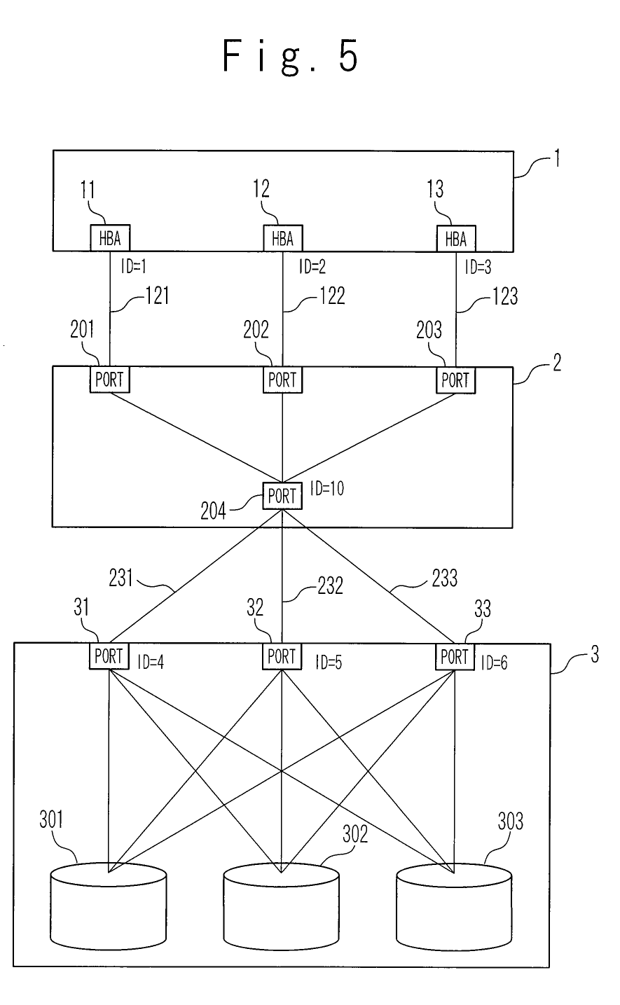

FIG. 5 is a block diagram showing a logical connection relation between the server 1 and the disc apparatus 3 when a virtual port is generated in the switching apparatus 2, in accordance with the configuration in this exemplary embodiment, in the system shown in FIG. 4. In FIG. 5, a virtual port 10 is arranged in the switching apparatus 2 in place of the ports 211 to 213 connected to the ports 31 to 33 of the disc apparatus 3. The virtual port 204 functions as the virtual port of the disc apparatus 3, and all of the accesses to the disc apparatus 3 from the server 1 are carried out through the virtual port 204. The frame is sent through the virtual port 204, to one port of the disc apparatus 3 that is suitably selected in the switching apparatus 2.

The port of the disc apparatus 3 is apparently only the virtual port. Thus, the routes to the disc apparatus that must be managed by the server 1 are only redundant routes between the switching apparatus 2 and the host bus adapters of the server 1. Thus, the apparent number of the routes is represented by n×m when the connection number between the host bus adapters and the switching apparatus 2 is assumed to be n and the connection number between the switching apparatus 2 and the disc apparatus 3 is assumed to be m. When the virtual port is not generated in FIG. 4, the apparent number of the routes is represented by n×m. However, the number of the routes is reduced to n×1 when the virtual port is generated in FIG. 5. As a result, the number of the routes to be managed by the server at the time of the trouble generation is reduced to 1/m, which can reduce the monitor cost of the server.

Next, the operation of this exemplary embodiment will be described below. The generation of the virtual port and the registration of the route data are carried out at the time of an initial setting of the switching apparatus 2 or at the time of configuration change. The server 1 sends a frame for configuration data setting as a setting signal to the virtual port managing section 24, in order to generate a virtual port in the switching apparatus 2. A special ID for management is given to the virtual port managing section 24, and the frame in which this ID is used as a destination ID is sent to the virtual port managing section 24 by the switch section 21. The virtual port managing section 24 sets a connection data of the virtual port to the virtual port storage section 25 in accordance with the content of this frame.

If the frame for configuration data setting can indicate a command for generation of a new virtual port to the virtual port managing section 24, an ID of the virtual port to be newly generated, and a port of the disc apparatus 3, the specific configuration is not especially limited. Also, the ID of the virtual port to be newly generated may be set by use of the frame for the configuration data setting or the virtual port managing section 24 may automatically assign a new ID in which is not used.

It should be noted that in this exemplary embodiment, the configuration data setting is carried out by use of the frame. However, otherwise, it is possible to employ an exemplary embodiment of using a management interface for IP communication provided in the switching apparatus. A communication method between the switching apparatus 2 and the server 1 may be of an optional type by which the configuration data can be sent.

Also, in this exemplary embodiment, the server 1 which accesses the disc apparatus 3 carries out the configuration data setting. However, an apparatus dedicated to manage the disc configuration 3 may be used to set the configuration data. If a system configuration is employed in which a predetermined data can be set to the switching apparatus 2, it is not especially limited to the configuration of this exemplary embodiment.

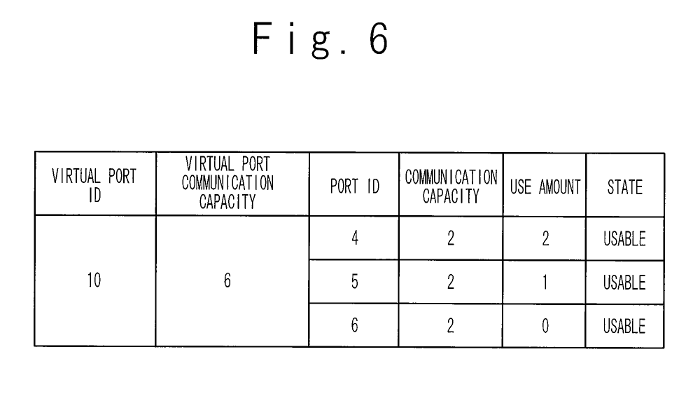

The virtual port managing section 24 uses the configuration data setting to set the data shown in FIG. 6 to the virtual port storage section 25 as the configuration data of the virtual port. The ID of the virtual port and the IDs of the ports of the disc apparatus 3 belonging to the virtual port are set in the configuration data of the virtual port.

When the frame sent to the virtual port is transferred to one of the ports constituting the virtual port, the port may be randomly selected so as to load distribution. Also, a processing possible frame amount may be managed as a communicable capacity by each port, in addition to the port data constituting the virtual port, and one of the ports having a large communicable capacity may be selected at the time of the transfer. Thus, it is possible to carry out the load distribution.

For example, in the fiber channel, the communicable capacity can be set to the credit number proportional to a capacity of a reception buffer assigned to each port or the number of exchanges that can be processed by each port. When the frame is transferred to a port of the disc apparatus 3, the frame is required to be transferred within the range of the reception buffer possessed by the port. If a frame transfer amount exceeds the capacity of the reception buffer, the frame transfer is temporally paused. When the reception buffer gets a margin after the completion of the process in the disc apparatus 3, the paused frame transfer is restarted.

Also, as the communicable capacity of the virtual port, it is possible to set the communicable capacity of each of the ports constituting the virtual port. The virtual port is constituted from the plurality of ports in the disc apparatus 3. Thus, the traffics from or to the server 1 are distributed to the respective ports. Thus, as the actually communicable capacity, it is possible to set a summation of the communicable capacities of the ports constituting the virtual port.

When the communicable capacity is set to the virtual port, it is possible to recognize the communicable capacity that can be currently used by the corresponding port, by increasing a communication amount of the port used when the frame is actually transferred to one of the ports constituting the virtual port, and decreasing the communication amount of the port when the frame for notifying the completion of the process in the port arrives. For example, when the credit number of the port is used as the communicable capacity, the summation of the credit numbers of the ports constituting the virtual port is set as the credit number of the virtual port. Thus, the virtual port virtually contains the buffers equivalent to the credit numbers constituting the virtual port.

The frame sent to the virtual port is sent to one of the ports constituting the virtual port which is suitably selected. However, the port having a margin in the credit number that can be used in the port is selected when the port is selected. Thus, even if there is no credit number that can be used in one port, namely, even when the frame cannot be sent because of no existence of the buffer of the port, the communication can be continued through a different port.

Also, when the frame sent to the port belonging to a certain node is processed, an ACK frame is returned from the node. Thus, the frame is identified in the switching apparatus 2 for managing the virtual port, and it is possible to recognize the credit number that can be currently used in the port.

Also, a value that is smaller than a summation of the communicable capacities of the ports may be set as a communicable capacity of this virtual port. By setting the value smaller than the summation, the summation of the traffics through the virtual port can be suppresses. Consequently, when a fault is not generated, it is possible to carry out the communication while having margins in the communicable capacities of the ports constituting the virtual port.

In this way, even if the fault is generated in any of the ports constituting the virtual port or on a route to the port so that the communication cannot be carried out, the operation can be continued without any fault notice to the server 1 when the communication is possible within the range of the communicable capacity set to the virtual port.

FIG. 6 is a diagram showing the configuration data of the virtual port generated in the virtual port storage section 25, in order to generate the virtual port shown in FIG. 5. The configuration data of FIG. 6 indicates that one virtual port is generated in the switching apparatus 2 and that the ID of the virtual port is set as 10.

When the ID of the virtual port is determined, an ID unique in the network is selected, and the server for setting the configuration data as mentioned above sets it. Next, a port address of the disc apparatus 3 constituting the virtual port is set as the configuration data of the virtual port.

In an example shown in FIG. 6, the IDs of the ports in the disc apparatus 3 shown in FIG. 5 are set as 4, 5 and 6, respectively. In this way, a data indicating that any of the ports belonging to the same disc apparatus 3 is a redundant port which can transparently access the disc apparatus 3 is given as the configuration data in advance by a designer of the system.

Also, in the example of FIG. 6, a total value of the communicable capacities representing the numbers of credits of the ports in the disc apparatus 3 is set as a communicable capacity which is the credit number of the virtual port. Here, 6 as a summation of the credit numbers of the ports ID4 to ID6 is registered as the credit number of the virtual port. Also, a use amount is stored for each port as the credit number used to send the frame. Also, in order to manage a fault situation of each port, the state of each port is held. In case of a usable state, the communication is allowed within the range of the communicable capacity. An unusable state is set when the communication is impossible because of the fault in the port of the disc apparatus 3 or because of the fault on the route between the switching apparatus 2 and the port of the disc apparatus 3.

Next, the operations of the respective sections of the switching apparatus 2 in case of the generation of the virtual port will be described below.

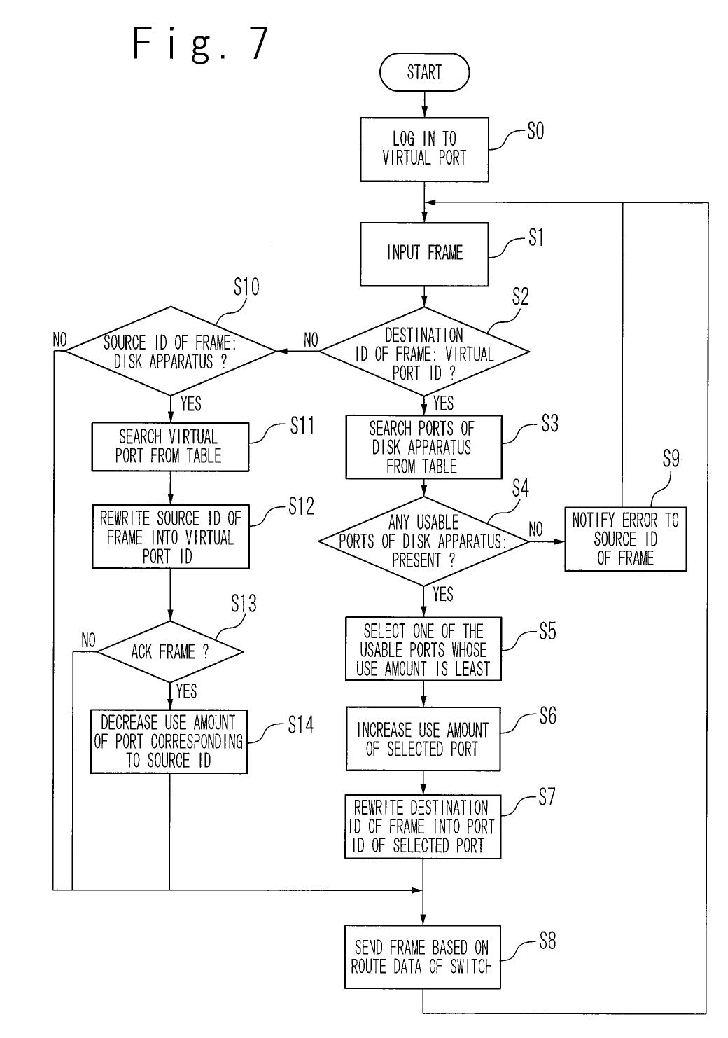

FIG. 7 is a flow chart showing an operation of the switching apparatus. At first, when the virtual port is generated, the virtual port is recognized as a port of a virtual disc apparatus when being viewed from the side of the server 1. Before starting the communication, the server 1 performs a port log-in on this virtual port. Subsequently, the virtual port managing section 24 searches the ID of the virtual port specified from the server 1 from the virtual port storage section 25 and returns a parameter such as a communicable capacity of the virtual port to the server 1 (Step S0).

The frame is sent from the server 1 to the switch section 21 (Step S1).

Next, the switch section 21 searches a route data storage section 23 and determines which of ports a destination address set in the frame is assigned to. If the destination ID of the frame indicates a virtual port ID, the frame is sent to the frame rewriting section 27 (Yes at Step S2).

Also, the switch section 21 sends the frame to the frame rewriting section 27 even if a transmission source ID of the frame is a port of the disc apparatus constituting the virtual port (Yes at Step S10).

In case other than the above cases (NO at Step S10), this indicates that the frame is not destined to the virtual port or the frame is not sent from the port constituting the virtual port. In this case, an output port 20 is selected in accordance with the route data stored in the route data storage section 23 and the frame is outputted, like a usual switching operation in which the virtual port is not set by the switch section 21.

If the frame is sent to the virtual port (YES at Step S2), the frame rewriting section 27 sends the destination ID of the frame to the virtual port searching section 26 and searches a port of the disc apparatus constituting the virtual port (Step S3).

The virtual port searching section 26 searches the virtual port storage unit 25 for the port of the disc apparatus 3 corresponding to the ID of the virtual port and determines whether or not the disc apparatus has usable ports (Step S4).

If all of the ports in the disc apparatus 3 cannot be used because of a fault (YES at Step S4), the port for the frame to be sent does not exist, resulting in a search error. The frame rewriting section 27 sends a frame indicating the error to the server 1 having the source ID for a fault notice (Step S9).

If any ports for the frame to be sent exists in the disc apparatus 3, the virtual port searching section 26 selects a port having the smallest use amount from the usable ports (Step S5).

Next, the virtual port searching section 26 increases the use amount of the selected port by “1” (Step S6).

The frame rewriting section 27 rewrites the destination ID of the frame to a new ID of the port selected at the step S5 and sends it to the switch section 21 (Step S7).

The switch section 21 searches the route data storage section 23 for the route data for the frame on the basis of the new destination ID, and determines the port 20 to which the frame is sent, and then sends the frame to the port 20 (Step S8).

Next, in case of YES at the step S10, the frame is sent from a port of the disc apparatus constituting the virtual port. The frame rewriting section 27 searches the virtual port searching section 26 related to the virtual port including the port, on the basis of the port ID of the disc apparatus 3 set as the source ID of the frame.

The virtual port searching section 26 returns the ID of the virtual port to the frame rewriting section 27, and the frame rewriting section 27 replaces the source ID of the frame with the ID of the virtual port (Step S12).

Next, if the frame is determined to be an ACK frame to the frame sent to the port of the disc apparatus 3 (YES at Step S13), the frame rewriting section 27 instructs the virtual port searching section 26 corresponding to the port to decrease the use amount of the searched port by “1”. The virtual port searching section 26 decreases the use amount of the corresponding port in the virtual port storage section 25 by “1” (Step S14).

In the frame rewriting section 27, if the frame is determined not to be the ACK frame and after it is determined to be the ACK frame and then the port use amount is decreased at the step S14, the frame is sent to the switch section 21.

Next, the switch section 21 searches the route data storage section 23 for the port 20 for the frame to be sent on the basis of the destination ID of the frame, and then sends the frame to the port 20 (Step S28).

### Second Exemplary Embodiment

The second exemplary embodiment of the present invention will be described below. Even in the second exemplary embodiment, the configuration of the switching apparatus 2 is similar to that of the first exemplary embodiment shown in FIG. 1.

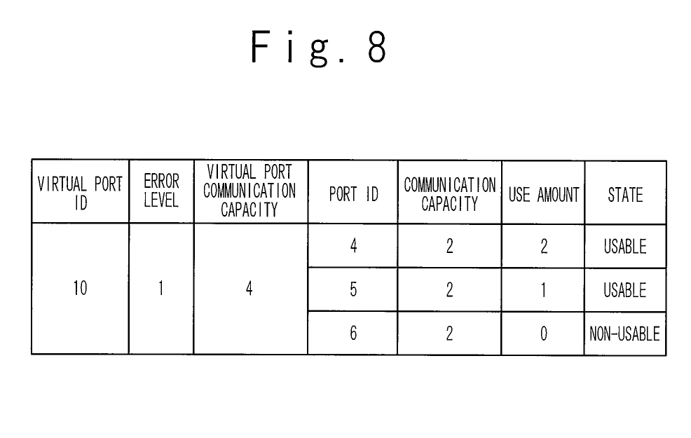

The second exemplary embodiment differs from the first exemplary embodiment in that an error level is set for every virtual port, as the storage data of the virtual port which is set in the virtual port storage section 25 by the virtual port managing section 24, as shown in FIG. 8.

When the virtual port is generated, the virtual port managing section 24 sets a maximum allowable number of faults in the port as the error level among the ports constituting the virtual port, when the communication to the port can be continued without notifying a fault notice to a node connected to the virtual port.

Moreover, the virtual port managing section 24 monitors states of the ports constituting the virtual port, and if an error is generated, sets the port to an unusable state.

In the example shown in FIG. 8, there are three ports constituting the virtual port. However, in this case, when one port is failed, the communication is continued without any fault notice and when the two or more ports are failed, the fault notice is notified.

Also, in the example of FIG. 8, the value of 4 is set as the communicable capacity of the virtual port. This is smaller than the value of 6 that is a summation of the communicable capacities of the ports. For this reason, even if the port of the port ID 6 having the communicable capacity of 2 is failed, there is no change in the preset usable communicable capacity. Thus, it is possible to continue the communication through the virtual port without sending any fault notice to a node connected to the virtual port.

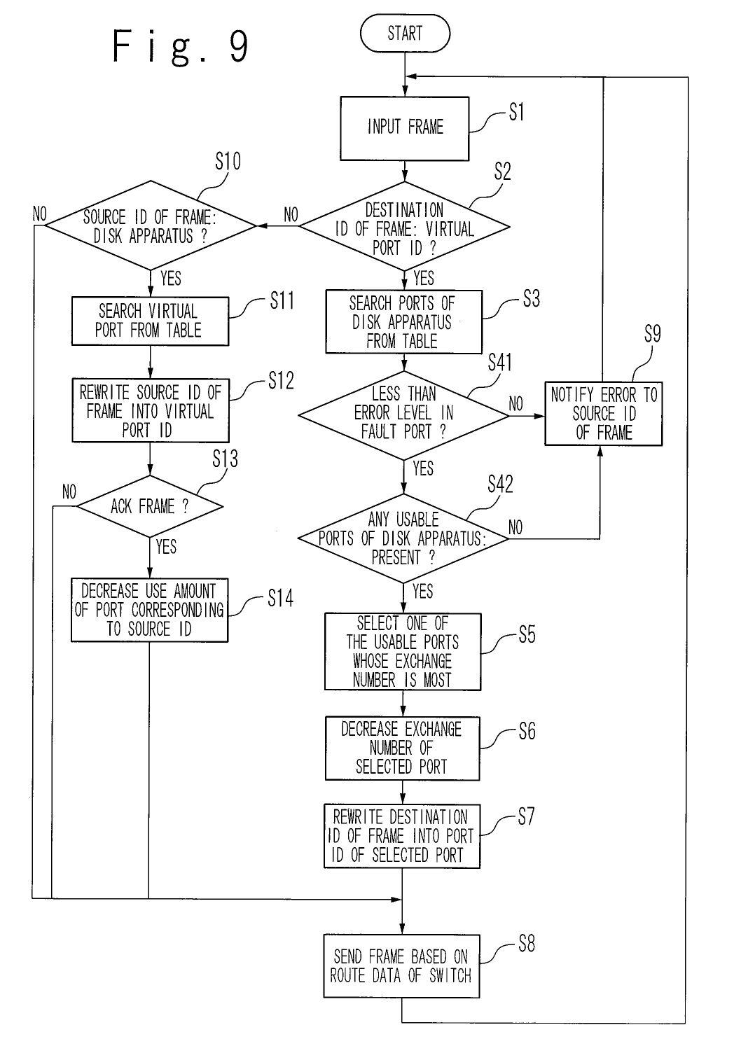

FIG. 9 shows the operation of the switching apparatus in this exemplary embodiment. FIG. 9 is substantially the same as the flow chart in the first exemplary embodiment shown in FIG. 7. However, FIG. 9 differs from FIG. 7 in that when the virtual port searching section 26 searches related to the virtual port at the step S3, if the number of unusable ports among the ports constituting the virtual port exceeds an error level, this fact is notified to the frame rewriting section 27 (Step S41).

If the error is notified (YES of Step S41), the frame rewriting section 27 notifies the error to the transmission source having the source ID of the frame to notify the fault generation in the virtual port.

Since a plurality of ports having one or more routes from the switching apparatus to a particular node are virtually integrated into a single section, the number of routes to be managed by the server decreases, and a process amount can be reduced when the fault is generated in the port.

While the present invention has been particularly shown and described with reference to the exemplary embodiments thereof, the present invention is not limited to these exemplary embodiments. It will be understood by those of ordinary skill in the art that various changes in form and details may be made therein without departing from the spirit and scope of the present invention as defined by the claims.

What is claimed is:

1. A switching apparatus which performs switching of a frame sent from a node, in a system of said switching apparatus and said node having redundant ports,
wherein said switching apparatus generates a virtual port based on an external setting signal, relates said redundant ports to said virtual port, and sends said frame to one of the ports of said node related to said virtual port when said frame is destined to said virtual port.

2. The switching apparatus according to claim 1, wherein said switching apparatus comprises:
a virtual port storage section configured to store a correspondence relation of an identifier of said virtual port and an identifier of the port;
a virtual port managing section configured to generate said virtual port based on the external setting signal and to store the virtual port identifier and the port identifier in said virtual port storage section;
a switch section configured to determine whether or not a destination identifier of said frame is said virtual port, and to send said frame to a frame rewriting section when said destination identifier of said frame is said virtual port;
said virtual port searching section configured to search said virtual port storage section for ports corresponding to said virtual port, to select one of the searched ports, and to reply the identifier of the selected port; and
said frame rewriting section configured to rewrite said destination identifier of said frame from said switch section with the identifier of the selected port and to send the rewritten frame to said switch section.

3. The switching apparatus according to claim 2, wherein said virtual port managing section acquires communicable capacities of the ports from said node, determines a communicable capacity of said virtual port from the communicable capacities of the ports, and
said virtual port storage section stores the communicable capacity of said virtual port.

4. The switching apparatus according to claim 3, wherein said virtual port managing section sets a value equal to or smaller than a summation of the communicable capacities of the ports to the communicable capacity of said virtual port.

5. The switching apparatus according to claim 3, wherein said virtual port searching section selects the one port of the ports based on a use quantity of each of the ports.

6. The switching apparatus according to claim 2, wherein said virtual port managing section stores an error level for said virtual port in said virtual port storage section, when any of the ports of said virtual port is failed, said error level being used to determine whether a fault notice should be notified to said node connected to said virtual port, sets an unusable state to the port of said virtual port storage section corresponding to the failed port, and determines a fault level from the fault situation of the ports,
said virtual port searching section selects one of usable ports, and notifies an error to said frame rewriting section when the fault level is equal to or higher than said error level, and
said frame rewriting section notifies an error to said source identifier of said frame when the error is notified from said virtual port searching section.

7. The switching apparatus according to claim 6, wherein the fault level is equal to a number of failed ports of the ports of said virtual port.

8. A frame exchanging method in a system of a switching apparatus and a node having redundant ports, said frame exchanging method comprising:
generating a virtual port based on an external setting signal;
relating one or more of the redundant ports of said node to a virtual port; and
sending said frame to one of the ports related to said virtual port when a destination of said frame is said virtual port.

9. The frame exchanging method according to claim 8, further comprising:
selecting one of the ports related to said virtual port when a destination identifier of said frame is said virtual port; and
rewriting said destination identifier of said frame with an identifier of the selected port.

10. The frame exchanging method according to claim 9, further comprising:
setting a communicable capacity to said virtual port based on the communicable capacities of the ports related to said virtual port.

11. The frame exchanging method according to claim 10, further comprising:
setting a value equal to or smaller than a summation of the communicable capacities of the ports to the communicable capacity of said virtual port.

12. The frame exchanging method according to claim 8, further comprising:
selecting one of usable ports related to said virtual port based on a usable communicable capacities of the usable ports.

13. The frame exchanging method according to claim 9, further comprising:
setting an error level used to determine whether a fault notice should be notified when any of the ports related to said virtual port is failed;
comparing the fault level and said error level, when any of the ports of said virtual port is failed;
sending said frame by using remaining ports of the ports related to said virtual port when the fault level is lower than the error level; and
returning an error to a source of said frame when the fault level is equal to or higher than the error level.

14. The frame exchanging method according to claim 13, wherein the fault level is equal to a number of failed ports of the ports of said virtual port.

15. A computer-readable software product in which a program of codes is written to execute a frame exchanging process, said frame exchanging process being in a system of a switching apparatus and a node having redundant ports, said frame exchanging process comprising:
generating a virtual port based on an external setting signal;
relating one or more of the redundant ports of said node to a virtual port; and
sending said frame to one of the ports related to said virtual port when a destination of said frame is said virtual port.

16. The computer-readable software product according to claim 15, wherein said frame exchanging process further comprises:
selecting one of the ports related to said virtual port when a destination identifier of said frame is said virtual port; and
rewriting said destination identifier of said frame with an identifier of the selected port.

17. The computer-readable software product according to claim 16, said frame exchanging process further comprises:
setting a communicable capacity to said virtual port based on the communicable capacities of the ports related to said virtual port.

18. The computer-readable software product according to claim 17, said frame exchanging process further comprises:
setting a value equal to or smaller than a summation of the communicable capacities of the ports to the communicable capacity of said virtual port.

19. The computer-readable software product according to claim 15, said frame exchanging process further comprises:
selecting one of usable ports related to said virtual port based on a usable communicable capacities of the usable ports.

20. The computer-readable software product according to claim 16, said frame exchanging process further comprises:
setting an error level used to determine whether a fault notice should be notified when any of the ports related to said virtual port is failed;
comparing the fault level and said error level, when any of the ports of said virtual port is failed;
sending said frame by using remaining ports of the ports related to said virtual port when the fault level is lower than the error level; and
returning an error to a source of said frame when the fault level is equal to or higher than the error level.

21. The computer-readable software product according to claim 20, wherein the fault level is equal to a number of failed ports of the ports of said virtual port.
